(19) United States
(12) Patent Application Publication
(10) Pub. No.: US 2014/0370263 A1
(43) Pub. Date: Dec. 18, 2014

(54) PLASTICIZABLE HEAT-INSULATING COMPOSITION, TRANSPARENT HEAT-INSULATING INTERMEDIATE SHEET AND TRANSPARENT HEAT-INSULATING SANDWICH-STRUCTURED PANEL

(71) Applicant: Taiflex Scientific Co., Ltd., Kaohsiung (TW)

(72) Inventors: Chen-Kuo LU, Kaohsiung (TW); Yu-Chih KAO, Kaohsiung (TW); Chia-Che CHUANG, Kaohsiung (TW); Tzu-Ching HUNG, Kaohsiung (TW)

(73) Assignee: Taiflex Scientific Co., Ltd., Kaohsiung (TW)

(21) Appl. No.: 14/018,832

(22) Filed: Sep. 5, 2013

(30) Foreign Application Priority Data
Jun. 18, 2013 (TW) 102121489

(51) Int. Cl. E04B 1/76; B32B 17/06; B32B 9/00

(52) U.S. Cl. CPC E04B 1/76; B32B 9/00; B32B 17/06
USPC 428/220; 252/62; 428/702; 428/432

(57) ABSTRACT

A plasticizable heat-insulating composition compatible with polyvinyl acetal resins and mixed with polyvinyl acetal resin for forming a mixture for a plasticizing process for making a transparent intermediate heat-insulating sheet, as well as a transparent heat-insulating sandwich-structured panel that demonstrates high transparency, high wide-range near infrared absorbance and high heat-insulation index, so as to improve their heat-insulating and energy-saving functions.

### BACKGROUND OF THE INVENTION

1. Field of the Invention

The present invention relates to a plasticizable heat-insulating composition which effectively blocks infrared beams, especially to a plasticizable composition which, when mixed with a resin material, directly forms a transparent heat-insulating intermediate sheet. Another aspect of the present invention relates to a transparent heat-insulating intermediate sheet and a transparent heat-insulating sandwich-structured panel which effectively block infrared beams.

2. Description of the Prior Art

Sunlight is used as a daytime light source to decrease the usage of indoor or car-interior light sources in order to save energy. It is also required that windows of a building or a vehicle be highly transparent to secure a necessary visibility for good sight and safe driving.

The spectrum of sunlight may be divided in ascending order according to wavelength into three fractions: ultraviolet, visible light and infrared. An infrared beam of a wavelength larger than 780 nm exhibits strong heating effect. Infrared absorbed by an object is converted to and released in the form of heat, which raises the temperature. Sunlight exposure allows infrared beams having wavelengths of 1200 nm to 1400 nm, 1600 nm to 1800 nm, and 2000 nm to 2400 nm to enter deep layers of human skin and reach heat-sensing synapses. Infrared beams having wavelengths of 1400 nm to 1600 nm and 1800 nm to 2000 nm enter heat-sensing regions of epidermal layers of the skin, which produces a heating feeling experienced by those exposed to sunlight for a period of time.

A conventional means confronting the uncomfortable feeling under sunlight comprises a transparent substrate and a heat-insulating membrane of metal or metal oxide plated on the transparent substrate. The heat-insulating membrane reflects or absorbs infrared beams to mitigate the heating feeling due to sunlight exposure. The conventional heat-insulating membrane reflects or absorbs infrared beams, however, at the same time shades visible light from passing through, which in turn fails to provide the necessary visibility.

In order to overcome the foregoing problem, another conventional approach employs expensive vacuum vapor deposition systems to prepare the heat-insulating membrane made of metal or metal oxide, which permits the membrane to be ultra-thin. The systems employed, however, also increase the cost and time for making the conventional heat-insulating membrane. Thus, a low-cost method for making a highly-transparent heat-insulating membrane has become an R&D topic that has gained significant attention in the field.

Taiwan Patent No. 1291455 has disclosed an infrared-blocking material. The infrared-blocking material comprises tungsten oxide micro particles and/or composite tungsten oxide micro particles. The tungsten oxide micro particles are of the formula: W_{y}O_{z}, 2.2≦z/y≦2.999, while the composite tungsten oxide micro particles are of the formula: MₓW_{y}O_{z}, 2.2≦z/y≦3.0, wherein M stands for a metal which may be alkaline metal, alkaline earth metal, rare earth metal, magnesium, zirconium or chromium. The infrared-blocking material of the aforementioned Taiwan patent, however, is of poor plasticizability and poor glueability, which makes said material unsuitable for plasticizing an intermediate sheet of a laminated glass panel.

In addition, Taiwan Patent Application Publication No. 201121894 has disclosed a transparent heat-insulating material, a method for making same, and a transparent heat-insulation structure. The transparent heat-insulating material comprises alkaline metal and halogen co-doped tungsten oxide. Optional bonding agents such as acrylic resin, polyvinyl butyral resin, tetraethoxyl silane or aluminium triisopropoxide, and optional dispersant such as unsaturated polybasic acid amines or inorganic acid esters, may be added in the process for making the transparent heat-insulating material. However, flow or disturbance due to volatilization of solvents aggravates unevenness of the thickness of the structure. The unevenness of the thickness of the structure makes it possible to apply the disclosed invention to make films of thicknesses ranging from 1 μm to 100 μm by spreading the material. However, it is significantly difficult to maintain the uniformity of the thickness of a sheet whose thickness is larger than 100 μm. The difficulty forbids the disclosed invention to be applied to make sheets of thicknesses larger than 100 μm. Furthermore, since polyvinyl butyral resin lacks plasticizability, polyvinyl butyral resin cannot be employed in a melting extrusion process to make a thermoplastic sheet of a thickness larger than 100 μm, and also the transparent heat-insulating material in a sheet fails to be appropriately dispersed, which leads to the failure to effectively raise the heat-insulation index of the sheet.

Taiwan Patent Publication No. 570871 has disclosed a heat-insulating sheet being transparent, heat-insulating, electromagnetic wave transmittable and weather resistant. Said heat-insulating sheet is made by steps including mixing polyvinyl butyral with particles of transparent conductive oxides materials such as indium tin oxide, antimony tin oxide, aluminum zinc oxide or indium zinc oxide to obtain a mixture, as well as melting and compression molding of the mixture, so as to obtain the aforementioned heat-insulating sheet. The heat-insulating sheet made from the foregoing materials allows no more than 20% transmittance for infrared beams of wavelengths ranging from 1500 nm to 2100 nm, however, the transmittance raises up to 70% for infrared beams of wavelengths ranging from 780 nm to 1500 nm, which indicates that the heat-insulating sheet fails to effectively block infrared lights. Said heat-insulating sheet also fails to provide an ideal near infrared reduction in terms of infrared beams having wavelengths of a wide range from 780 nm to 2400 nm.

To overcome the shortcomings that conventional heat-insulating materials fails to provide plasticizability and near infrared reduction effectiveness, the present invention provides a plasticizable heat-insulating composition, a transparent heat-insulating intermediate sheet and a transparent heat-insulating sandwich-structured panel to mitigate or obviate the aforementioned problems.

### SUMMARY OF THE INVENTION

The main objective of the invention is to provide a plasticizable heat-insulating composition compatible with polyvinyl acetal resins and with polyvinyl acetal resin forming a mixture for a plasticizing process for making a transparent intermediate heat-insulating sheet.

The plasticizable heat-insulating composition in accordance with the present invention has 5 to 99.9 weight parts of plasticizer, and 0.1 to 95 weight parts of heat-insulating particles selected from the group consisting of CsₓWO_{3-y}, CsₓWO_{3-y}Cl_{y}, CsₓSn_{z}WO_{3-y}Cl_{y}, CsₓSb_{z}WO_{3-y}Cl_{y} and CsₓBi_{z}WO_{3-y}Cl_{y}, wherein 0<x<1, 0<y≦0.5, 0<z≦1, W stands for tungsten, O stands for oxygen, Cs stands for cesium, Sn stands for tin, Sb stands for antimony, and Bi stands for bismuth.

According to the present invention, the plasticizable heat-insulating composition has a suitable ratio of the plasticizer and the heat-insulating particles. Thus, the plasticizable heat-insulating composition, when mixed with polyvinyl acetal resin, provides plasticizability and effective near infrared reduction function. Furthermore, no aggregation occurs in said composition, such that the composition may be plasticized to form a transparent heat-insulating intermediate sheet of a thickness ranging from 100 μm to 5 mm, which has an ideal visible light transmittance, so as to lower the cost for making a transparent heat-insulating intermediate sheet and to raise application value thereof.

According to the present invention, the plasticizer is a solvent compatible with polyvinyl acetal resins and has a boiling point higher than 200 degrees Celsius.

Preferably, the plasticizer is an aliphatic monoepoxy carboxylate having a carbon number of 9 to 20 (C9-20), a C9-20 aliphatic polyepoxy carboxylate, a C9-20 alicyclic monoepoxy carboxylate, a C9-20 alicyclic polyepoxy carboxylate, a C4-22 aliphatic diol diester, a C4-22 aliphatic dicarboxylate diester, or a combination thereof.

Specifically, the plasticizer is triethylene glycol ethylhexanoate.

Preferably, an average diameter of the heat-insulating particles is less than or equal to 100 nm so as to raise the transparency of the transparent heat-insulating intermediate sheet made from the plasticizable heat-insulating composition, and to lower the haze value of said transparent heat-insulating intermediate sheet.

Another aspect of the present invention is to provide a transparent heat-insulating intermediate sheet capable of effectively blocking infrared beams, and a transparent heat-insulating sandwich-structured panel having said sheet. Specifically, the transparent heat-insulating intermediate sheet and the transparent heat-insulating sandwich-structured panel having same are capable of effectively blocking infrared beams having wavelengths ranging from 780 nm to 1500 nm and infrared beams having wavelengths ranging from 1500 nm to 2400 nm. In other words, said sheet and panel have improved near infrared reduction and heat-insulation indices in terms of infrared beams having wavelengths of a wide range.

In order to achieve the foregoing effect, the present invention provides a transparent heat-insulating intermediate sheet made by plasticization of a mixture, wherein the mixture comprises polyvinyl acetal resin and the aforementioned plasticizable heat-insulating composition. The quantity of the polyvinyl acetal resin is 100 weight parts and the quantity of the plasticizable heat-insulating composition is 0.01 to 60 weight parts.

Preferably, the polyvinyl acetal resin is polyvinyl butyral resin, polyvinyl formal resin or a combination thereof.

Preferably, the mixture comprises 100 weight parts of polyvinyl acetal resin and optionally comprises 0.01 to 5 weight parts of ultraviolet absorber, 0.01 to 10 weight parts of dispersant and/or 0.01 to 5 weight parts of adhesion modifier, so that the transparent heat-insulating intermediate sheet made from the mixture has improved anti-ultraviolet effectiveness and improved adhesiveness to a substrate.

Hereby, the ultraviolet absorber includes at least one compound selected from the group consisting of malonic ester compounds, oxamide substituted aniline compounds, benzophenone compounds, triazine compounds, triazole compounds, benzoate compounds, and hindered amine compounds. Suitable malonate compounds include, but not limited to, dimethyl malonate, diethyl malonate, and 2-(2′-hydroxy-5′-tert-octylphenyl) benzotriazole. Suitable oxamide substituted aniline compounds include, but not limited to, 2-ethyl-2′-ethoxy-acid-ceramide substituted aniline. Suitable benzophenone compounds include, but not limited to, 4-octyloxy benzophenone. Suitable triazine compounds include, but not limited to, terphenyl-triazine, ethylhexyl triazine, and 2-(4,6-diphenyl-1,3,5-triazin-2-yl)-5-[(hexyl) oxy]-phenol. Suitable benzoate compounds include, but not limited to, amino benzoate, methyl salicylate, benzyl benzoate, and 3,5-di-tert-butyl-4-hydroxybenzoic acid hexadecyl ester.

The dispersant includes at least one compound selected from the group consisting of sulfuric ester compounds, phosphate compounds, ricinoleic acids, ricinoleic acid polymers, polycarboxylic acids, silanes, polyol type surfactants, polyvinyl alcohol and polyvinyl butyral.

The adhesiveness modifier includes at least a compound selected from the group consisting of alkali metal organic salts, alkaline earth metal organic salts, alkali metal salts, alkaline earth metal salts, modified silicone oils, or a combination thereof. According to the present invention, suitable alkali metal organic salts include, but not limited to, potassium acetate, potassium propionate, and potassium 2-ethylhexanoate. Suitable alkaline earth metal organic salts include, but not limited to, magnesium acetate, magnesium propionate, magnesium 2-ethylbutyrate, and magnesium 2-ethylhexanoate. Suitable alkali metal salts include, but not limited to, lithium chloride, sodium chloride, potassium chloride, and potassium nitrate. Suitable alkaline earth metal salts include, but not limited to, magnesium chloride and magnesium nitrate. Suitable denatured silicone oils include, but not limited to, epoxy-modified silicone oil and ether-modified silicone oil.

In the present disclosure, a term “heat insulting index” is used to describe the near-infrared ray (NIR) absorbing property at a wavelength of 950 nm and visible-light (VIS) transmittance property at a wavelength of 550 nm of a sheet. Heat insulting index is the sum of the value of the NIR absorbance of a sheet and the value of the VIS transmittance of the sheet times 100. Generally, light transmittance (T %) within a specified wavelength range can be determined by a spectrometer, and light absorbance within the same range is obtained by subtracting the light transmittance from 100%.

Preferably, the NIR T % of the transparent heat-insulating intermediate sheet in terms of infrared light having wavelengths ranging from 1200 nm to 1500 nm is less than or equal to 12%, more preferably, less than 6%.

Specifically, the NIR T % of the transparent heat-insulating intermediate sheet at a wavelength of 1200 nm is less than or equal to 12%, more preferably, less than or equal to 8%; the NIR T % of the transparent heat-insulating intermediate sheet at a wavelength of 1400 nm is less than or equal to 8%, more preferably, less than or equal to 5%; the NIR T % of the transparent heat-insulating intermediate sheet at a wavelength of 1600 nm is less than or equal to 6%, more preferably, less than or equal to 5.6%. With the foregoing features, the NIR T % of the transparent heat-insulating intermediate sheet in accordance with the present invention has higher NIR reduction for infrared light of a wide range of wavelengths, and higher heat-insulation index.

Preferably, the transparent heat-insulating intermediate sheet has a thickness ranging from 100 μm to 5 mm.

Preferably, the transparent heat-insulating intermediate sheet has a haze value less than or equal to 0.9.

Still another aspect of the present invention is to provide a transparent heat-insulating sandwich-structured panel having two transparent substrates and the aforementioned transparent heat-insulating intermediate sheet sandwiched between the transparent substrates.

Preferably, the transparent heat-insulating sandwich-structured panel is a transparent sandwich-structured glass panel.

In accordance with the present invention, the NIR T % of the transparent heat-insulating sandwich-structured panel at the wavelengths ranging from 1200 nm to 1500 nm is larger than 92%, the NIR T % of said panel in terms of infrared light at the wavelengths ranging from 1500 nm to 2400 nm is larger than 90%. The haze value of said panel is less than 0.3.

Preferably, each of said substrates is made from a material selected from the group consisting of glass, polyethylene terephthalate, polybutylene terephthalate, polycarbonate, vinyl acetate copolymer, and a combination thereof. Each of said substrates may be made from a transparent glass, a green glass, a highly-infrared-reflecting metal-plated glass or a highly-infrared-absorbing metal-plated glass.

As abovementioned, the plasticizable heat-insulating composition has an appropriate ratio of plasticizers and heat-insulating particles, and that the plasticizers are compatible with polyvinyl acetal resin. Thus said composition is capable of being plasticized into a transparent heat-insulating intermediate sheet. Since the transparent heat-insulating intermediate sheet has the appropriate ratio of plasticizers and heat-insulating particles, the transparent heat-insulating intermediate sheet in accordance with the present invention and the transparent heat-insulating sandwich-structured panel having said sheet have better transparency, higher wide-range NIR reduction, and higher heat-insulation index compared to conventional means, which makes said sheet and said panel in accordance with the present invention more suitable for being used as heat-insulation and energy-saving means in buildings or vehicles.

### DETAILED DESCRIPTION OF THE PREFERRED EMBODIMENTS

Other objectives, advantages and novel features of the invention will become more apparent from the following detailed description. Even though numerous characteristics and advantages of the present invention have been set forth in the description, together with details of the features of the invention, the disclosure is illustrative only. Changes may be made within the principles of the invention to the full extent indicated by the broad general meaning of the terms in which the appended claims are expressed.

### Embodiment 1

Cs_{0.33}WO_{2.97} and triethylene glycol ethylhexanoate were mixed at the weight ratio of 1:80. The weight of the amount of Cs_{0.33}WO_{2.97} used herein was defined as one weight part. 0.1 weight part of polyphosphate was added to the mixed Cs_{0.33}WO_{2.97} and triethylene glycol ethylhexanoate as a dispersant. After thorough stirring, a Cs_{0.33}WO_{2.97} suspension was obtained.

Zirconium oxide beads with a diameter of 1 mm were used to mill the Cs_{0.33}WO_{2.97} suspension at 1000 rpm for 6 hours to obtain a milled Cs_{0.33}WO_{2.97} solution, which completed the manufacture of a plasticizable heat-insulating composition. The average diameter of milled Cs_{0.33}WO_{2.97} particles dispersed in the suspension was 38 nm.

100 weight parts of polyvinyl butyral resin, 40 weight parts of the plasticizable heat-insulating composition, 0.06 weight part of magnesium 2-ethylbutyrate, 0.25 weight part of 2-(2′-hydroxy-5′-tert-octylphenyl) benzotriazole, 0.1 weight part of 3,5-di-tert-butyl-4-hydroxybenzoic acid hexadecyl ester were mixed to obtain a mixture for plasticizing a transparent heat-insulating intermediate sheet, wherein the mixture comprises approximately 0.5 weight part of Cs_{0.33}WO_{2.97}.

Subsequently, the mixture was poured into a single-screw extruder having a T die at 190 degrees Celsius. A transparent heat-insulating intermediate sheet having an average thickness of 0.38 mm was then extruded.

The transparent heat-insulating intermediate sheet was sandwiched between two substrates, and the intermediate sheet and the substrates were together placed in a rubber bag in a 3000-Pa environment to be vacuumed for 20 minutes. The substrates used herein were float glass panels. In the instant embodiment, each of these substrates has a NIR T % of 92% at the wavelengths ranging from 1200 nm to 1500 nm, as well as a NIR T % of 90% in terms of infrared beams of wavelengths larger than 1500 nm or less than or equal to 2400 nm. The haze value thereof was 0.3.

Afterwards, in the aforementioned vacuuming environment, place these two substrates, which were float glass panels, with the transparent heat-insulating intermediate sheet sandwiched there between to a pressing machine to be vacuum-pressed for 30 minutes at 90 degrees Celsius, followed by a continuous pressing process for 20 minutes in an autoclave at 135 degrees Celsius and under a pressure of 1.2 MPa. A transparent heat-insulating sandwich-structured panel with the aforementioned transparent heat-insulating intermediate sheet sandwiched therein was obtained. Said panel was a transparent sandwich-structured glass panel.

### Embodiment 2

The plasticizable heat-insulating composition and the mixture, which comprises said composition, used in the instant embodiment were approximately the same with the plasticizable heat-insulating composition and the mixture used in Embodiment 1. The differences between the instant embodiment and Embodiment 1 are that the heat-insulating particles used in the instant embodiment are Cs_{0.33}WO_{2.97}Cl_{0.02}, and that the amount of polyvinyl butyral used was defined as 100 weight parts while the amount of heat-insulating Cs_{0.33}WO_{2.97}Cl_{0.02} particles used was 0.5 weight part.

The mixture of Embodiment 2 for being plasticized into a transparent heat-insulating intermediate sheet was processed with the process as described in Embodiment 1 to obtain a transparent heat-insulating intermediate sheet and a transparent sandwich-structured glass panel holding said sheet.

### Embodiment 3

The plasticizable heat-insulating composition and the mixture, which comprises said composition, used in the instant embodiment were approximately the same with the plasticizable heat-insulating composition and the mixture used in Embodiment 1. The heat-insulating particles used in the instant embodiment are Cs_{0.33}Sn_{0.16}WO_{2.97}Cl_{0.02}, and that the amount of polyvinyl butyral used was defined as 100 weight parts while the amount of heat-insulating Cs_{0.33}Sn_{0.16}WO_{2.97}Cl_{0.02} particles used was 0.5 weight part.

The mixture of Embodiment 3 for being plasticized into a transparent heat-insulating intermediate sheet was processed with the process as described in Embodiment 1 to obtain a transparent heat-insulating intermediate sheet and a transparent sandwich-structured glass panel holding said sheet.

In comparison to the foregoing Embodiments 1-3, Comparative Examples 1-4 are provided as follows.

### Comparative Example 1

The composition used in the instant comparative example was approximately the same with the plasticizable heat-insulating composition as described in Embodiment 1. The composition used in the instant comparative example, however, comprises no heat-insulating particles.

The composition used in Comparative Example 1 was used to make a mixture. The mixture was used to manufacture an intermediate sheet and a sandwich-structured glass panel comprising said intermediate sheet via the process described in Embodiment 1.

### Comparative Example 2

The composition used in the instant comparative example and a mixture comprising said composition were approximately the same with the plasticizable heat-insulating composition and the mixture comprising the plasticizable heat-insulating composition as described in Embodiment 1. In the composition used in the instant comparative example, however, the heat-insulating Cs_{0.33}WO_{2.97} particles of Embodiment 1 were replaced with antimony tin oxide particles. In said mixture, the amount of polyvinyl butyral used was defined as 100 weight parts while the amount of antimony tin oxide particles used was 0.5 weight part.

The mixture used in Comparative Example 2 was used to manufacture an intermediate sheet and a sandwich-structured glass panel comprising said intermediate sheet via the process described in Embodiment 1.

### Comparative Example 3

The composition used in the instant comparative example and a mixture comprising said composition were approximately the same with the composition and the mixture comprising composition as described in Comparative Example 2. In the instant comparative example, the amount of polyvinyl butyral used was defined as 100 weight parts while the amount of antimony tin oxide particles used was 1 weight part.

The mixture used in Comparative Example 3 was used to manufacture an intermediate sheet and a sandwich-structured glass panel comprising said intermediate sheet via the process described in Comparative Example 2.

### Comparative Example 4

The composition used in the instant comparative example was approximately the same with the plasticizable heat-insulating composition as described in Embodiment 1, except that the Cs_{0.33}WO_{2.97} and triethylene glycol ethylhexanoate had been neither milled nor well dispersed before directly mixing Cs_{0.33}WO_{2.97} at the ratio as described in Embodiment 1 with polyvinyl butyral, triethylene glycol ethylhexanoate, magnesium 2-ethylbutyrate, 2-(2′-hydroxy-5′-tert-octylphenyl) benzotriazole, and 3,5-di-tert-butyl-4-hydroxybenzoic acid hexadecyl ester to obtain a mixture, which was then poured into a single-screw extruder having a T die at 190 degrees Celsius to extrude a transparent heat-insulating intermediate sheet having an average thickness of 0.38 mm.

Subsequently, an intermediate sheet and a sandwich-structured glass panel were then made via the process described in Embodiment 1.

### Experimental Example

The present experimental example employed UV-VIS spectrometer to measure the transmittance (%) of the transparent sandwich-structured glass panels of Embodiments 1-3 and the sandwich-structured glass panels of Comparative Examples 1-4. The results are shown in Table 1. Further, a haze meter is used to measure the haze values of the sandwich-structured glass panels of Embodiments 1-3 and Comparative Examples 1-4. The haze values are also shown in Table 1.

In addition, the heat-insulation indices of the sandwich-structured glass panels are also calculated and shown in the following Table 1. The heat-insulation indices of the transparent sandwich-structured glass panels of the embodiments and the sandwich-structured glass panels of the comparative examples are obtained by multiplying by 100 the sum of the VIS T % at a 550 nm wavelength and the NIR absorbance (NIR Abs %) at a 1200 nm wavelength, wherein the NIR Abs % at a wavelength of 1200 nm of a sheet is obtained by subtracting from 1 a NIR transmittance (NIR T %) at a wavelength of 1200 nm from 100%.

TABLE 1

| | VIS T % | NIR T % | | | | Heat- | |
|---|---|---|---|---|---|---|---|
| | @550 | @1200 | @1400 | @1600 | @2400 | Insulation | Haze |
| Samples | nm (%) | nm (%) | nm (%) | nm (%) | nm (%) | Index | Value |
| Embodiment 1 | 80.5 | 7.3 | 4.8 | 4.7 | 5.5 | 173.2 | 0.9 |
| Embodiment 2 | 81 | 7.5 | 5 | 4.8 | 5.5 | 173.5 | 0.9 |
| Embodiment 3 | 80.2 | 7.6 | 5 | 4.8 | 5.6 | 172.6 | 0.9 |
| Comparative | 91 | 76 | 73 | 80 | 13 | 115 | 0.3 |
| Example 1 | | | | | | | |
| Comparative | 85 | 57 | 48 | 42 | 5 | 128 | 0.5 |
| Example 2 | | | | | | | |
| Comparative | 81 | 55.4 | 40.5 | 26.3 | 1 | 125.6 | 0.9 |
| Example 3 | | | | | | | |
| Comparative | 77.6 | 76.1 | 75.2 | 75.2 | 66.5 | 101.5 | 19.8 |
| Example 4 | | | | | | | |

As listed in the preceding table, in comparison to the sandwich-structured glass panel of Comparative Example 1, which comprises no heat-insulating particles, each of the transparent sandwich-structured glass panels of Comparative Examples 1-3, with their infrared-blocking intermediate sheet, has demonstrated significant raise in wide-range NIR Abs %.

Furthermore, the comparison of Embodiments 1-3 and Comparative Examples 2-3 has demonstrated that, due to the fact that each of the plasticizable heat-insulating compositions of the embodiments comprises a suitable ratio of plasticizer and heat-insulating particles, each of the plasticizable heat-insulating compositions has shown significantly lowered NIR transmittance in terms of infrared lights of wavelengths of 1200 nm, 1400 nm and 1600 nm. The heat-insulation indices of transparent sandwich-structured glass panels of Embodiments 1-3 are also significantly higher than the heat-insulation indices of the sandwich-structured glass panels of the comparative examples, which has indicated that the plasticizable heat-insulating composition in accordance with the present invention is a polyvinyl-acetal-resin-compatible material which not only is suitable for a plasticizing process for making an intermediate sheet in a sandwich-structured glass panel, but also significantly raise the wide-range NIR reduction and the heat-insulation index.

The comparison of Embodiment 1 and Comparative Example 4 has demonstrated that the heat-insulating particles of Comparative Example 4, which is neither milled nor well-dispersed in polyvinyl butyral, tend to aggregate and produce aggregations with diameters larger than 10 μm, which significantly raises the haze value of the sandwich-structured glass panels to 19.8. Further, in an aspect of infrared absorption, the enlarged heat-insulating particle aggregation reduces the sum of the area of the glass panel permeable for perpendicularly incident infrared beams, which consequently decreases infrared absorption and thus lowers the heat-insulation index to 101.5. In contrast, the preceding milling processes have lowered the diameters of the heat-insulating particles, or aggregation thereof, to less than 100 nm. The sum of the area of the transparent sandwich-structured glass panel of Embodiment 1 permeable for perpendicularly incident infrared lights is thus enlarged such that the heat-insulation index is significantly raised to a high level of 173.

The results of the Experimental Example have demonstrated that the plasticizable heat-insulating composition in accordance with the present invention is nanometer-scaled and polyvinyl-acetal-resin-compatible and thus capable of providing ideal heat-plasticizability, which makes said plasticizable heat-insulating composition suitable to form a mixture with polyvinyl acetal resin. A transparent heat-insulating intermediate sheet and a transparent heat-insulating sandwich-structured panel made from said mixture has advantages such as lower haze value, higher wide-range NIR reduction and outstanding heat-insulation index.

The disclosure of the above embodiments and examples is illustrative only and is not in any way for posing limitations to the invention claimed in the claims.

What is claimed is:

1. A plasticizable heat-insulating composition comprising:
5 to 99.9 weight parts of plasticizer;
0.1 to 95 weight parts of heat-insulating particles made from at least one material selected from the group consisting of CsₓWO_{3-y}, CsₓWO_{3-y}Cl_{y}, CsₓSn_{z}WO_{3-y}Cl_{y}, CsₓSb_{z}WO_{3-y}Cl_{y} and CsₓBi_{z}WO_{3-y}Cl_{y}, wherein 0<x<1, 0<y≦0.5 and 0<z≦1.

2. The plasticizable heat-insulating composition as claimed in claim 1, wherein the plasticizer is a solvent compatible with polyvinyl acetal resins and has a boiling point higher than 200 degrees Celsius.

3. The plasticizable heat-insulating composition as claimed in claim 2, wherein the plasticizer is selected from the group consisting of an aliphatic monoepoxy carboxylate having a carbon number of 9 to 20, an aliphatic polyepoxy carboxylate having a carbon number of 9 to 20, an alicyclic monoepoxy carboxylate having a carbon number of 9 to 20, an alicyclic polyepoxy carboxylate having a carbon number of 9 to 20, an aliphatic diol diester having a carbon number of 4 to 22, an aliphatic dicarboxylate diester having a carbon number of 4 to 22, and a combination thereof.

4. The plasticizable heat-insulating composition as claimed in claim 3, wherein the plasticizer is triethylene glycol ethylhexanoate.

5. The plasticizable heat-insulating composition as claimed in claim 1, wherein an average diameter of the heat-insulating particles is less than or equal to 100 nm.

6. A transparent heat-insulating intermediate sheet, which is formed by plasticizing a mixture, the mixture comprising:
100 weight parts of polyvinyl acetal resin; and
0.01 to 60 plasticizable heat-insulating composition as claimed in claim 1.

7. The transparent heat-insulating intermediate sheet as claimed in claim 6, wherein the transparent heat-insulating intermediate sheet has a thickness of 100 μm to 5 mm.

8. The transparent heat-insulating intermediate sheet as claimed in claim 6, wherein a product of multiplying a sum of a value of a visible-light transmittance and a value of a near infrared absorbance of the transparent heat-insulating intermediate sheet by 100 is larger than or equal to 170.

9. The transparent heat-insulating intermediate sheet as claimed in claim 8, wherein the product of multiplying the sum of the value of the visible-light transmittance and the value of the near infrared absorbance of the transparent heat-insulating intermediate sheet by 100 is larger than or equal to 173.

10. The transparent heat-insulating intermediate sheet as claimed in claim 6, wherein a haze value of the transparent heat-insulating intermediate sheet is less than or equal to 0.9.

11. The transparent heat-insulating intermediate sheet as claimed in claim 6, wherein the polyvinyl acetal resin is selected from the group consisting of polyvinyl butyral resin, polyvinyl formal resin and a combination thereof.

12. The transparent heat-insulating intermediate sheet as claimed in claim 11, wherein the mixture further comprises 0.01 to 5 weight parts of ultraviolet absorber selected from the group consisting of malonic ester compounds, oxamide substituted aniline compounds, benzophenone compounds, triazine compounds, triazole compounds, benzoate compounds, and hindered amine compounds.

13. The transparent heat-insulating intermediate sheet as claimed in claim 11, wherein the mixture further comprises 0.01 to 10 weight parts of dispersant selected from the group consisting of sulfuric ester compounds, phosphate compounds, ricinoleic acids, ricinoleic acid polymers, polycarboxylic acids, silanes, polyol type surfactants, polyvinyl alcohol, and polyvinyl butyral.

14. The transparent heat-insulating intermediate sheet as claimed in claim 11, wherein the mixture further comprises 0.01 to 5 weight parts of adhesion modifier including at least a compound selected from the group consisting of alkali metal organic salts, alkaline earth metal organic salts, alkali metal salts, alkaline earth metal salts, modified silicone oils, and a combination thereof.

15. A transparent heat-insulating sandwich-structured panel comprising:
two transparent substrates; and
the transparent heat-insulating intermediate sheet as claimed in claim 6, wherein the transparent heat-insulating intermediate sheet is sandwiched between the transparent substrates.

16. The transparent heat-insulating sandwich-structured panel as claimed in claim 15, wherein each of the substrates is made from a material selected from the group consisting of glass, polyethylene terephthalate, polybutylene terephthalate, polycarbonate, vinyl acetate copolymer and a combination thereof.
